(19) United States
(12) Patent Application Publication
(10) Pub. No.: US 2024/0387808 A1
(43) Pub. Date: Nov. 21, 2024

(54) METHOD FOR MANUFACTURING SILICON CLATHRATE ELECTRODE ACTIVE MATERIAL, AND METHOD FOR MANUFACTURING LITHIUM-ION BATTERY

(71) Applicant: TOYOTA JIDOSHA KABUSHIKI KAISHA, Toyota-shi (JP)

(72) Inventors: Naohiro MASHIMO, Atsugi-shi (JP); Mitsutoshi OTAKI, Susono-shi (JP); Jun YOSHIDA, Mishima-shi (JP); Kayoko YUKAWA, Kariya-shi (JP); Masanori HARATA, Kariya-shi (JP); Yasuhiro YAMAGUCHI, Kariya-shi (JP); Tatsuya EGUCHI, Kariya-shi (JP)

(73) Assignee: TOYOTA JIDOSHA KABUSHIKI KAISHA, Toyota-shi (JP)

(21) Appl. No.: 18/630,533

(22) Filed: Apr. 9, 2024

(30) Foreign Application Priority Data
May 16, 2023 (JP) 2023-080981

(51) Int. Cl. H01M 4/38; H01M 4/02; H01M 10/0525

(52) U.S. Cl. CPC H01M 4/386; H01M 10/0525; H01M 2004/027

(57) ABSTRACT

The present disclosure provides a method for manufacturing a silicon clathrate positive electrode active material capable of removing at least a portion of a type I silicon clathrate, and a method for manufacturing a lithium-ion battery comprising manufacturing such a silicon clathrate electrode active material. Disclosed methods of making silicon clathrate electrode active material, comprising the following steps: (a) providing silicon clathrate particle that contain a type I silicon clathrate and a type II silicon clathrate, and (b) contacting the silicon clathrate particle with a hydrofluoric solution to remove at least a portion of the type I silicon clathrate.

### FIELD

The present disclosure relates to a method for manufacturing a silicon clathrate electrode active material and a method for manufacturing a lithium-ion battery.

### BACKGROUND

In recent years, there has been ongoing development of batteries. For example, in the automotive industry, the development of batteries for use in electric vehicles or hybrid vehicles has been advancing. In addition, silicon is known as an electrode active material used in batteries, particularly lithium-ion batteries.

Silicon electrode active materials have a large theoretical capacity and are effective in high energy densification of batteries. However, silicon electrode active materials have a problem of large expansion during charging. On the other hand, it is known that using a silicon clathrate electrode active material as a silicon electrode active material suppresses expansion during charging.

For example, PTL 1 discloses a silicon clathrate electrode active material comprising a silicon clathrate type II crystal phase and including voids inside primary particle, wherein a void amount of the voids having a fine pore diameter of 100 nm or less is 0.05 cc/g or more and 0.15 cc/g or less.

### CITATION LIST

### Patent Literature

[PTL 1] Japanese Unexamined Patent Publication (Kokai) No. 2021-158004

### SUMMARY

### Technical Problem

Types of silicone clathrate crystalline include type I silicone clathrate and type II silicone clathrate. In particular, in type II silicone clathrate, lithium is efficiently occluded in the cage structure portion of the crystal, and thus the expansion and contraction during charging-discharging of the battery is small.

In this context, it is desired to develop methods for removing type I silicone clathrates from silicone clathrates containing both type I silicone clathrates and type II silicone clathrates.

An object of the present disclosure is to provide a method for manufacturing a silicon clathrate positive electrode active material capable of removing at least a portion of a type I silicon clathrate, and a method for manufacturing a lithium-ion battery comprising manufacturing such a silicon clathrate electrode active material.

### Solution to Problem

The present inventors have discovered that the above object can be achieved by the following means.

### <Aspect 1>

A method for manufacturing a silicon clathrate electrode active material, comprising the following steps:
(a) providing a silicon clathrate particle containing a type I silicon clathrate and a type II silicon clathrate, and
(b) contacting the silicon clathrate particle with a hydrogen fluoride solution to remove at least a portion of the type I silicon clathrate.

### <Aspect 2>

The method according to Aspect 1, wherein in the step (b), the ratio of the amount of substance of the hydrogen fluoride solution to the mass of the silicon clathrate particle is greater than 0.0060 mol/g and less than 0.2500 mol/g.

### <Aspect 3>

The method according to Aspect 1 or 2, wherein the solvent of the hydrogen fluoride solution is a mixed solvent of water and an organic solvent.

### <Aspect 4>

The method according to any one of Aspects 1 to 3, wherein in the mixed solvent, the ratio of the mass of the water to a total mass of the water and the organic solvent is 30% by mass or greater and 90% by mass or less.

### <Aspect 5>

The method according to any one of Aspects 1 to 4, wherein the silicon clathrate electrode active material is for a negative electrode active material of lithium-ion batteries.

### <Aspect 6>

A method for manufacturing a lithium-ion battery, comprising the following steps:
manufacturing a silicone clathrate electrode active material by the method according to any one of Aspects 1 to 5, and
forming an electrode active material layer containing the silicon clathrate electrode active material.

### Advantageous Effects of Invention

According to the method of the present disclosure for manufacturing a silicon clathrate electrode active material, at least a portion of a type I silicon clathrate can be removed. Further, according to the present disclosure, it is possible to provide a method for manufacturing a lithium-ion battery comprising manufacturing such a silicon clathrate electrode active material.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

### <<Method for Manufacturing Silicon Clathrate Electrode Active Material>>

The disclosed method for manufacturing a silicon clathrate electrode active material, comprising the following steps: (a) providing a silicon clathrate particle containing a type I silicon clathrate and a type II silicon clathrate, and (b) contacting the silicon clathrate particle with a hydrogen fluoride solution to remove at least a portion of the type I silicon clathrate.

The present inventors have discovered that the type I silicon clathrate and the type II silicon clathrate differed in their solubility in the hydrogen fluoride solution. Specifically, the type I silicon clathrate has higher solubility in the hydrogen fluoride solution. Therefore, it is considered that the type I silicon clathrate can be removed from the silicon clathrate particle by contacting the silicon clathrate particle containing the type I silicon clathrate and the type II silicon clathrate with the hydrogen fluoride solution.

By removing the type I silicone clathrate with a larger expansion and contraction during the charging-discharging of the battery compared to the type II silicone clathrate, the increase of the restrained pressure during the charging-discharging is suppressed because the ratio of the type II silicone clathrate is relatively larger.

The “electrode active material” relating to the present disclosure can be used as a “positive electrode active material” or a “negative electrode active material”, and is used particularly as a “negative electrode active material”.

### <Provision of Silicone Clathrate Particle>

The method of the present disclosure comprises providing a silicon clathrate particle containing a type I silicon clathrate and a type II silicon clathrate.

Such silicone clathrate particles can be prepared by preparing sodium silicone (NaSi) alloys and removing sodium from NaSi alloys.

Specifically, a NaSi alloy is prepared by first reacting a silicon source with a sodium source such as sodium hydride. Thereafter, a silicon clathrate particle can be prepared by heating the NaSi alloy thus prepared to remove sodium from the NaSi alloy to form clathrate. Alternatively, a silicon clathrate particle can be prepared by reacting the NaSi alloy thus prepared with aluminum fluoride as a sodium trapping agent to remove sodium from the NaSi alloy to form clathrate.

### <Removal of Type I Silicon Clathrate>

The method of the present disclosure comprises contacting the silicon clathrate particle with a hydrogen fluoride solution to remove at least a portion of the type I silicon clathrate.

In the method of the present disclosure, the ratio of the amount of substance of the hydrogen fluoride solution (mol) to the mass of the silicon clathrate particle (g) (HF[mol]/Si [g]) is preferably 0.006 mol/g or greater and 0.25 mol/g or less. The ratio may be 0.01 mol/g or greater, 0.02 mol/g or greater, 0.03 mol/g or greater, 0.04 mol/g or greater, or 0.05 mol/g or grater, and may be 0.20 mol/g or less, 0.15 mol/g or less, 0.13 mol/g or less, or 0.11 mol/g or less. If the ratio is within the above range, the type I silicone clathrate can be removed highly selectively from the silicone clathrate particle.

The solvent of the hydrogen fluoride solution may be water, an organic solvent, or a mixed solvent of water and an organic solvent. When this solvent contains water, i.e., a mixed solvent of water and an organic solvent, particularly a mixed solvent of water and an organic solvent, it is preferable in that the production of by-product such as sodium silicofluoride (Na₂SiF₆) is suppressed.

In addition, when the contact is accompanied by a mixing operation such as stirring, bubbles will be generated when the solvent is only water. In contrast, when the solvent is a mixed solvent of water and an organic solvent, generation of bubbles can be suppressed.

In the mixed solvent, the ratio of the mass of the water to the total mass of the water and the organic solvent may be 30% by mass or greater and 90% by mass or less. The ratio may be 40% by mass or greater, 50% by mass or greater, 60% by mass or greater, 70% by mass or greater, 80% by mass or greater, or 85% by mass, and may be 89% by mass or less, 88% by mass or less, or 87% by mass or less.

The organic solvent can be any organic solvent that can dissolve hydrogen fluoride. When an organic solvent is used in combination with water, the organic solvent may be any organic solvent that can dissolve hydrogen fluoride and is compatible with water. The organic solvent is preferably an alcohol, more preferably a lower alcohol, and still more preferably ethanol.

The time for contacting the silicon clathrate particle with the hydrogen fluoride solution may be 0.1 h or more, 0.3 h or more, or 0.5 h or more, and may be within 6 h, within 5 h, or within 4 h.

The content ratio of the type I silicone clathrate and the type II silicone clathrate in the silicone clathrate particle can be calculated from, for example, the peak-intensity ratio in the measured result of X-ray diffraction (XRD).

### <Uses>

The silicon clathrate electrode active material in the method of the present disclosure can be used for a negative electrode active material of lithium-ion batteries.

### <<Manufacturing Method for Lithium-Ion Battery>>

The method of the present disclosure for manufacturing a lithium-ion battery, comprising the following steps: manufacturing a silicon clathrate electrode active material, and forming an electrode active material layer containing the silicon clathrate electrode active material.

The above descriptions relating to the method for manufacturing a silicon clathrate electrode active material of the present disclosure can be referenced regarding the method for manufacturing a silicon clathrate electrode active material.

The method for forming the electrode active material layer is not particularly limited, and a known method can be employed. For example, when the negative electrode active material layer contains the silicon clathrate electrode active material of the present disclosure, a slurry containing the silicon clathrate electrode active material is coated on the negative electrode current collector and dried, whereby an electrode active material layer, that is, a negative electrode active material layer formed on the negative electrode current collector layer can be obtained.

A method for forming a battery is not particularly limited, and a known method can be employed. Hereinafter, a method for manufacturing a battery when the negative electrode active material layer contains the silicon clathrate electrode active material of the present disclosure will be described.

A method for manufacturing a battery in the present disclosure may comprises, in addition to manufacturing a silicon clathrate electrode active material and forming a negative electrode active material layer containing a silicon clathrate electrode active material, disposing a negative electrode current collector layer, a negative electrode active material layer, an electrolyte layer, a positive electrode active material layer, and a positive electrode current collector layer in this order.

### <Negative Electrode Current Collector Layer>

The material used for the negative electrode current collector layer is not particularly limited. Any material that can be used as a negative electrode current collector of a battery can be appropriately adopted. For example, the material may be, but is not limited to, copper, copper alloy, or copper plated or vapor-deposited with nickel, chromium, or carbon.

The shape of the negative electrode current collector layer is not particularly limited, and can include, for example, foil-like, plate-like, or mesh-like. Among these, a foil-like shape is preferable.

### <Negative Electrode Active Material Layer>

The negative electrode active material layer of the present disclosure is a layer containing a negative electrode active material and optionally a solid electrolyte, a conductive aid, and a binder.

### (Negative Electrode Active Material)

The negative electrode active material comprises the silicon clathrate electrode active material of the present disclosure.

### (Electrolyte)

The material of the solid electrolyte is not particularly limited. Any material that is usable as a solid electrolyte used in lithium-ion batteries can be used. For example, the solid electrolyte may be a sulfide solid electrolyte.

Examples of the sulfide solid electrolyte include, but are not limited to, sulfide amorphous solid electrolytes, sulfide crystalline solid electrolytes, and argyrodite-type solid electrolytes. Specific examples of the sulfide solid electrolyte can include, but are not limited to, Li₂S—P₂S5-based (such as Li₇P₃S₁₁, Li₃PS₄, and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆ and Li₁₀GeP₂S₁₂), LiI—Li₂S—P₂O₅, LiI—Li₃PO₄—P₂S₅, and Li₇₋ₓPS₆₋ₓClₓ; and combinations thereof.

The sulfide solid electrolyte may be a glass or a crystallized glass (glass ceramic).

When the negative electrode active material layer contains a solid electrolyte, the mass ratio (mass of silicon clathrate electrode active material:mass of solid electrolyte) of the silicon clathrate electrode active material to the solid electrolyte in the negative electrode active material layer is preferably 85:15 to 30:70, and more preferably 80:20 to 40:60.

The electrolytic solution preferably contains supporting salt of the electrolytic solution and a solvent.

Examples of the supporting salt (lithium salt) of the electrolytic solution having lithium-ion conducting properties include inorganic lithium salts such as LiPF₆, LiBF₄, LiClO₄, and LiAsF₆; and organic lithium salts such as LiCF₃SO₃, LiN(CF₃SO₂)₂, LiN(C₂F₅SO₂)₂, LiN(FSO₂)₂, and LiC(CF₃SO₂)₃.

Examples of the solvent used in the electrolytic solution include cyclic esters (cyclic carbonates) such as ethylene carbonate (EC), propylene carbonate (PC), and butylene carbonate (BC); and chain esters (chain carbonates) such as dimethyl carbonate (DMC), diethyl carbonate (DEC), and ethyl methyl carbonate (EMC). The electrolytic solution preferably contains two or more solvents.

### (Conductive Aid)

The conductive aid is not particularly limited. For example, the conductive aid may be, but is not limited to, VGCF (vapor-grown carbon fiber), acetylene black (AB), ketjen black (KB), carbon nanotube (CNT), or carbon nanofiber (CNF).

### (Binder)

The binder is not particularly limited. For example, the binder may be of, but is not limited to, a material such as polyvinylidene fluoride (PVdF), butadiene rubber (BR), or styrene-butadiene rubber (SBR), or a combination thereof.

The thickness of the negative electrode active material layer may be, for example, 0.1 to 1000 μm, preferably 1 to 100 μm, and even more preferably 30 to 100 μm.

### <Electrolyte Layer>

The electrolyte layer comprises at least an electrolyte. In addition, the electrolyte layer may comprise a binder in addition to the electrolyte, as needed. The above descriptions relating to the negative electrode active material layer of the present disclosure can be referenced regarding the electrolyte and the binder.

The thickness of the electrolyte layer, for example, is 0.1 to 300 μm, and preferably 0.1 to 100 μm.

### <Positive Electrode Active Material Layer>

The positive electrode active material layer is a layer containing a positive electrode active material and optionally an electrolyte, a conductive aid, and a binder.

The material of the positive electrode active material is not particularly limited. For example, the positive electrode active material may be, but is not limited to, lithium cobaltate (LiCoO₂), lithium nickelate (LiNiO₂), lithium manganate (LiMn₂O₄), LiCo_{1/3}Ni_{1/3}Mn_{1/3}O₂, a heteroelement-substituted Li—Mn spinel having a composition represented by Li₁₊ₓMn_{2-x-y}M_{y}O₄ (M is one or more metal elements selected from Al, Mg, Co, Fe, Ni, and Zn), lithium titanate (LiₓTiO_{y}), or lithium metal phosphate (LiMPO₄, where M is one or more metals selected from Fe, Mn, Co, and Ni).

The positive electrode active material can comprise a covering layer. The covering layer is a layer containing a material that has lithium-ion conducting performance, has low reactivity with the positive electrode active material and the solid electrolyte, and can maintain the form of a covering layer that does not flow even when brought into contact with the active material or the solid electrolyte. Specific examples of the material constituting the covering layer can include, but are not limited to, Li₄Ti₅O₁₂ and Li₃PO₄, in addition to LiNbO₃.

Examples of shapes of the positive electrode active material include particulate. The average particle size (D50) of the positive electrode active material is not particularly limited, and for example, is 10 nm or more, and may be 100 nm or more. The average particle size (D50) of the positive electrode active material is, for example, 50 μm or less, and may be 20 μm or less. The average particle size (D50) can be calculated from measurements with, for example, a laser diffraction particle size distribution analyzer or a scanning electron microscope (SEM).

The above descriptions relating to the negative electrode active material layer of the present disclosure can be referenced regarding the electrolyte, the conductive aid, and the binder.

When the positive electrode active material layer contains a solid electrolyte, the mass ratio (mass of positive electrode active material:mass of solid electrolyte) of the positive electrode active material to the solid electrolyte in the positive electrode active material layer is preferably 85:15 to 30:70, and more preferably 80:20 to 50:50.

The thickness of the positive electrode active material layer, for example, is 0.1 μm to 1000 μm, preferably 1 μm to 100 μm, and even more preferably 30 μm to 100 μm.

### <Positive Electrode Current Collector Layer>

The material used for the positive electrode current collector layer is not particularly limited. Any material that can be used as a positive electrode current collector of a battery can be appropriately adopted. For example, the material may be, but is not limited to, SUS, nickel, chromium, gold, platinum, aluminum, iron, titanium, zinc, or one of these metals plated or vapor-deposited with nickel, chromium, or carbon.

The shape of the positive electrode current collector layer is not particularly limited, and can include, for example, foil-like, plate-like, or mesh-like. Among these, a foil-like shape is preferable.

The lithium ion battery manufactured by the method of the present disclosure may be a liquid-based battery containing an electrolytic solution as an electrolyte layer, and may be a solid-state battery having a solid electrolyte layer as an electrolyte layer. The “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte.

The lithium-ion battery manufactured by the method of the present disclosure may be a primary battery or a secondary battery.

The shape of the lithium-ion battery, for example, coin-type, laminate-type, cylindrical-type, square-type.

### EXAMPLES

### Synthesis of Silicone Clathrate Electrode Active Material

### Alloying

### Synthetic Example 1

As a silicon (Si) source, Si powder (Japan Pure Chemical Co., Ltd., SIEPB32) was prepared. The Si powder and metallic lithium (Li) were weighed at a molar ratio of Li/Si=4.0, the weighed Si powder and Li were mixed in a mortar in an argon atmosphere to obtain a lithium-silicon (LiSi) alloy. The obtained LiSi alloy was reacted with ethanol in an argon atmosphere and further treated with hydrogen fluoride (HF) to obtain a powder having primary particle with voids therein, i.e., Si powder having a porous structure.

The Si powder having a porous structure and sodium hydride (NaH) as a sodium (Na) source were used to manufacture a sodium-silicon (NaSi) alloy. It should be noted that the NaH used was preliminarily washed with hexane. The NaH and the Si powder having a porous structure were weighed at a molar ratio of 1.05:1, and the weighed NaH and Si powder having a porous structure were mixed with a cutter mill. The obtained mixture was heated under the conditions of 500° C. and 40 h in an argon atmosphere with a heating furnace to obtain a powdery NaSi alloy.

### <Clathration>

Aluminium fluoride (AlF₃) and NaSi alloy was weighed so that the ratio of the amount of substance of AlF₃ to the amount of substance of NaSi alloy was 0.34, and the weighed NaSi alloy and AlF3 were mixed with a cutter mill to obtain a reaction starting material. The obtained powdery reaction starting material was placed in a reaction vessel made of stainless steel and heated under the conditions of 340° C. and 60 h in an argon atmosphere with a heating furnace to allow a reaction to obtain a reaction product comprising silicon clathrate particle. The obtained reaction product was acid-washed using a mixed solvent of HNO₃ and H₂O mixed at a volume ratio of 10:90 to remove by-products in the reaction product. After washing, the reaction product was filtered, and the filtered solid content was dried at 120° C. for 3 h or more to obtain a composition comprising silicon clathrate particle which contained type I silicon clathrate and type II silicon clathrate.

### Synthetic Examples 2 to 5

A composition containing silicon clathrate particle of Synthesis Examples 2 to 5 was obtained in the same manner as in Synthesis Example 1, except that the manufacturing conditions in the clathration were as shown in Table 1.

Table 1 shows the content ratio of each component and the ratio of the mass of type II silicon clathrate to the total mass of the type I silicon clathrate and the type II silicon clathrate in the composition containing the silicon clathrate particle of each synthetic example. The content ratio was calculated from the peak-intensity ratio in XRD result. In Table 1 and Tables 2 and 3, which are described below, the “type II” indicates type II silicone clathrate and the “type I” indicates the type I silicone clathrate.

TABLE 1

| | Clathration conditions | | | | | | | type II/ |
|---|---|---|---|---|---|---|---|---|
| | AlF₃/NaSi | Heating | Heating | | | | | (type I + |
| | (molar | temperature | time | Content ratio [% by mass] | | | | type II) |
| | ratio) | [° C.] | [h] | type II | type I | Na₂SiF₆ | Others | [%] |
| Synthetic | 0.34 | 340 | 60 | 91.26 | 7.96 | 0 | 0.78 | 91.98 |
| Example 1 | | | | | | | | |
| Synthetic | 0.34 | 340 | 60 | 85.25 | 14.75 | 0 | 0 | 85.25 |
| Example 2 | | | | | | | | |
| Synthetic | 0.34 | 340 | 20 | 94.4 | 4.3 | 0 | 1.29 | 95.64 |
| Example 3 | | | | | | | | |
| Synthetic | 0.34 | 340 | 60 | 85.2 | 7.2 | 0 | 7.6 | 92.21 |
| Example 4 | | | | | | | | |
| Synthetic | 0.34 | 330 | 20 | 82.1 | 3.2 | 0 | 14.63 | 96.25 |
| Example 5 | | | | | | | | |

### Removal of Type I Silicon Clathrate

### Example 1

TI 2.2 g of the composition containing the silicon clathrate particle of Synthesis Example 1, 75 ml of ion-exchanged water and 20 ml of ethanol were added and stirred so that the ratio of the mass of water to the total mass of water and ethanol was 86.7% by mass. 46-wt % HF aqueous solution was added thereto so that HF [mol]/Si [g] was 0.0055 mol/g. The solution was reacted by stirring for 0.5 h to remove the type I silicon clathrate. The obtained reaction solution was filtered and the filtered solids were washed three times with 50 ml of ion-exchanged water and further washed once with 20 ml of ethanol After washing and drying overnight at 120° C. to obtain a silicon clathrate electrode active material of Example 1.

### Examples 2 to 8

The silicon clathrate electrode active material of Examples 2 to 8 were obtained in the same manner as in Example 1, except that the conditions for removing the type I silicon clathrate were as described in Table 2.

The results of Examples 1 to 8 are shown in Table 2 for the yield of the type I silicone clathrate removal step, the content ratio of each component in the silicone clathrate electrode active material, and the ratio of the mass of the type II silicone clathrate to the total mass of the type I silicone clathrate and the type II silicone clathrate. In Table 2 and Table 3 described below, “Si” indicates a composition containing the silicon clathrate particle.

TABLE 2

| | | Type I removal step | | | | | | | type II/ |
|---|---|---|---|---|---|---|---|---|---|
| | | | Stirring | | | | | | (type I + |
| | | HF[mol]/ | time | Yield | content ratio [% by mass] | | | | type II) |
| | Si | Si[g] | [h] | [%] | type II | type I | Na₂SiF₆ | Others | [%] |
| Example 1 | Synthetic | 0.0055 | 0.5 | 90.5 | 93.2 | 5.5 | 0 | 1.25 | 94.43 |
| | Example 1 | | | | | | | | |
| Example 2 | Synthetic | 0.0545 | 0.5 | 71.4 | 98 | 1 | 0 | 1.3 | 98.99 |
| | Example 1 | | | | | | | | |
| Example 3 | Synthetic | 0.1091 | 0.5 | 69.5 | 98.6 | 0.5 | 0 | 0.9 | 99.5 |
| | Example 1 | | | | | | | | |
| Example 4 | Synthetic | 0.0545 | 0.5 | 74.1 | 99.22 | 0.78 | 0 | 0 | 99.22 |
| | Example 2 | | | | | | | | |
| Example 5 | Synthetic | 0.0545 | 1.5 | 68.2 | 99.8 | 0.2 | 0 | 0 | 99.8 |
| | Example 2 | | | | | | | | |
| Example 6 | Synthetic | 0.0545 | 3 | 66.4 | 99.8 | 0.2 | 0 | 0 | 99.8 |
| | Example 2 | | | | | | | | |
| Example 7 | Synthetic | 0.0545 | 1 | 68.0 | 98.85 | 0 | 0 | 1.15 | 100 |
| | Example 3 | | | | | | | | |
| Example 8 | Synthetic | 0.0545 | 3 | 60.2 | 98.27 | 0 | 0 | 1.73 | 100 |
| | Example 3 | | | | | | | | |

As shown in Examples 1 to 3 in Table 2, after the type I silicone clathrate removal step, the content ratio of the type I silicone clathrate decreased. According to the method of Examples 2 and 3 with HF[mol]/Si [g] as 0.0545 mol/g, and 0.1091 mol/g, respectively, the type I silicone clathrate could be removed highly selectively.

As shown in Examples 4 to 6 in Table 2, the type I silicone clathrate could be removed highly selectively even if the stirring time in the type I silicone clathrate removal step was different.

As shown in Examples 7 and 8 of Table 2, when the removal of the type I silicon clathrate was carried out using a composition comprising silicon clathrate particle having a low content ratio of type I silicon clathrate, the type I silicon clathrate could be completely removed.

### Example 9

To 2.2 g of the composition containing the silicon clathrate particle, 100 ml of ethanol was added and stirred. 46-wt % HF aqueous solution was added thereto so that HF[mol]/Si [g] was 0.0449 mol/g. The solution was reacted by stirring for 3 h to remove the type I silicon clathrate. The obtained reaction solution was filtered and the filtered solids were washed eight times with 25 ml of ethanol. After washing and drying overnight at 60° C. to obtain a silicon clathrate electrode active material of Example 9.

### Example 10

A silicon clathrate electrode active material of Example 10 was obtained in the same manner as in Example 9, except that the conditions for removing the type I silicon clathrate were changed as described in Table 3.

TABLE 3

| | | Type I removal step | | | | | | | type II/ |
|---|---|---|---|---|---|---|---|---|---|
| | | | Stirring | | | | | | (type I + |
| | | HF[mol]/ | time | Yield | Content ratio[% by mass] | | | | type II) |
| | Si | Si[g] | [h] | [%] | type II | type I | Na₂SiF₆ | Others | [%.] |
| Example 9 | Synthetic | 0.0449 | 3 | 69.4 | 85.9 | 0.4 | 6.8 | 6.9 | 99.54 |
| | Example 4 | | | | | | | | |
| Example 10 | Synthetic | 0.2674 | 6.3 | 27.6 | 9 | 0 | 22.3 | 68.7 | 100 |
| | Example 5 | | | | | | | | |

As shown in Table 3, in the method of Example 9, the type I silicone clathrate could be removed highly selectively. However, it is considered that because only ethanol was used as the solvent in the type I silicone clathrate removal step, the ratio of Na₂SiF₆ as a by-product was large.

In the method of Example 10, the type I silicone clathrate could be removed. However, since HF[mol]/Si [g] was large and the stirring time of the type I silicone clathrate rate removal step was too long, not only type I silicone clathrate but also II type silicone clathrate was dissolved. Therefore, it is thought the yield was low and the ratio of type II silicone clathrate was small. Furthermore, it is thought that because only ethanol was used as the solvent in that step, the ratio of Na₂SiF₆ as a by-product was large.

1. A method for manufacturing a silicon clathrate electrode active material, comprising the following steps:
(a) providing a silicon clathrate particle containing a type I silicon clathrate and a type II silicon clathrate, and
(b) contacting the silicon clathrate particle with a hydrogen fluoride solution to remove at least a portion of the type I silicon clathrate.

2. The method according to claim 1, wherein in the step (b), the ratio of the amount of substance of the hydrogen fluoride solution to the mass of the silicon clathrate particle is greater than 0.0060 mol/g and less than 0.2500 mol/g.

3. The method according to claim 1, wherein the solvent of the hydrogen fluoride solution is a mixed solvent of water and an organic solvent.

4. The method according to claim 1, wherein in the mixed solvent, the ratio of the mass of the water to a total mass of the water and the organic solvent is 30% by mass or greater and 90% by mass or less.

5. The method according to claim 1, wherein the silicon clathrate electrode active material is for a negative electrode active material of lithium-ion batteries.

6. A method for manufacturing a lithium-ion battery, comprising the following steps:
manufacturing a silicone clathrate electrode active material by the method according to claim 1, and
forming an electrode active material layer containing the silicon clathrate electrode active material.
